(19) United States
(12) Patent Application Publication
(10) Pub. No.: US 2025/0200344 A1
(43) Pub. Date: Jun. 19, 2025

(54) APPROXIMATION-FREE NEURAL NETWORK MAPPING

(71) Applicants: International Business Machines Corporation, Armonk, NY (US); ECOLE POLYTECHNIQUE FEDERALE DE LAUSANNE (EPFL), Lausanne (CH)

(72) Inventors: Ana Stanojevic, Zurich (CH); Stanislaw Andrzej Wozniak, Kilchberg (CH); Giovanni Cherubini, Rueschlikon (CH); Angeliki Pantazi, Thalwil (CH); Guillaume Bellec, Ecublens (CH); Wulfram Gerstner, Ecublens (CH)

(21) Appl. No.: 18/539,326

(22) Filed: Dec. 14, 2023

(51) Int. Cl. G06N 3/049

(52) U.S. Cl. CPC G06N 3/049

(57) ABSTRACT

A computer-implemented method includes accessing neural network (NN) components of a pre-trained analog-signal-based NN. The NN components are processed to generate scaled NN components. Based at least in part on one or more of the scaled NN components, temporal-coding-based NN components of a temporal-coding-based NN are generated. The temporal-coding-based NN components are dependent on the one or more of the scaled NN components.

### STATEMENT REGARDING PRIOR DISCLOSURES BY THE INVENTOR OR A JOINT INVENTOR

The following disclosure is submitted under 35 U.S.C. 102(b)(1)(A):

DISCLOSURE: “An Exact Mapping From ReLU Networks to Spiking Neural Networks,” Stanojevic et al.; arXiv: 2212.12522v1 [cs.NE] 23 Dec. 2022; 20 pages.

### BACKGROUND

The present invention relates in general to programmable computers that implement neural networks. More specifically, the present invention relates to computer-implemented methods, computer systems, and computer program products that perform approximation-free mapping of a task performed by a source neural network to a task performed by a target neural network.

### SUMMARY

Embodiments of the invention are directed to a computer-implemented method that includes accessing neural network (NN) components of a pre-trained analog-signal-based NN. The NN components are processed to generate scaled NN components. Based at least in part on one or more of the scaled NN components, temporal-coding-based NN components of a temporal-coding-based NN are generated. The temporal-coding-based components are dependent on the one or more of the scaled NN components.

Embodiments of the invention are also directed to computer systems and computer program products having substantially the same features and functionality as the computer-implemented method described above.

Additional features and benefits are realized through techniques described herein. Other embodiments and aspects are described in detail herein. For a better understanding, refer to the description and to the drawings.

### BRIEF DESCRIPTION OF THE DRAWINGS

The subject matter which is regarded as embodiments is particularly pointed out and distinctly claimed in the claims at the conclusion of the specification. The foregoing and other features and benefits of the embodiments are apparent from the following detailed description taken in conjunction with the accompanying drawings in which:

FIG. 1 depicts an exemplary computing environment operable to implement aspects of the invention;

FIG. 2 depicts a simplified sketch of a biological neuron, which is modeled by computer systems in accordance with aspects of the invention;

FIG. 3A depicts a simplified block diagram illustrating a model of a biological neuron operable to be utilized in neural network architectures in accordance with aspects of the invention;

FIG. 3B depicts a simplified block diagram illustrating a deep learning neural network architecture in accordance with aspects of the invention;

FIG. 4A depicts a simplified block diagram illustrating a spiking neural network (SNN) architecture operable to be utilized in implementing aspects of the invention;

FIG. 4B depicts a simplified block diagram illustrating a single-spike SNN (SS-SNN) architecture operable to be utilized in implementing aspects of the invention;

FIG. 4C depicts a graph illustrating an example of a spiking neuron's membrane potential behavior during a spike in accordance with aspects of the invention;

FIG. 5A depicts a simplified block diagram illustrating an approximation-free neural network mapping architecture in accordance with aspects of the invention;

FIG. 5B depicts a simplified block diagram illustrating an approximation-free neural network mapping architecture in accordance with aspects of the invention;

FIG. 5C depicts a simplified block diagram illustrating an approximation-free neural network mapping architecture in accordance with aspects of the invention;

FIG. 6A depicts a simplified block diagram illustrating a portion of the mapping functionality depicted in FIG. 5C;

FIG. 6B depicts a simplified block diagram illustrating additional detail of how the portion of the mapping functionality depicted in FIG. 6A can be implemented in accordance with aspects of the invention;

FIG. 6C depicts an algorithm operable to implement the portion of the mapping functionality depicted in FIG. 6B in accordance with aspects of the invention;

FIG. 6D depicts equations associated with the algorithm shown in FIG. 6C;

FIG. 7A depicts a simplified block diagram illustrating a portion of the mapping functionality depicted in FIG. 5C;

FIG. 7B depicts a simplified block diagram illustrating additional detail of how the portion of the mapping functionality depicted in FIG. 7A can be implemented in accordance with aspects of the invention;

FIG. 7C depicts an algorithm operable to implement the portion of the mapping functionality depicted in FIG. 7B in accordance with aspects of the invention;

FIG. 8 depicts a diagram illustrating how mapping functionality can be implemented in accordance with aspects of the invention;

FIG. 9 depicts equations illustrating how mapping functionality can be implemented in accordance with aspects of the invention;

FIG. 10 depicts equations illustrating how mapping functionality can be implemented in accordance with aspects of the invention; and

FIG. 11 depicts a table illustrating performance results for an approximation-free neural network mapping architecture in accordance with aspects of the invention.

In the accompanying figures and following detailed description of the disclosed embodiments, the various elements illustrated in the figures are provided with three-digit reference numbers. In some instances, the leftmost digits of each reference number corresponds to the figure in which its element is first illustrated.

### DETAILED DESCRIPTION

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Many of the functional units of the systems described in this specification have been labeled as modules. Embodiments of the invention apply to a wide variety of module implementations. For example, a module can be implemented as a hardware circuit including custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like. Modules can also be implemented in software for execution by various types of processors. An identified module of executable code can, for instance, include one or more physical or logical blocks of computer instructions which can, for instance, be organized as an object, procedure, or function. Nevertheless, the executables of an identified module need not be physically located together but can include disparate instructions stored in different locations which, when joined logically together, function as the module and achieve the stated purpose for the module.

The various components/modules of the systems illustrated herein are depicted separately for ease of illustration and explanation. In embodiments of the invention, the functions performed by the various components/modules can be distributed differently than shown without departing from the scope of the various embodiments of the invention describe herein unless it is specifically stated otherwise.

Although this detailed description includes references to modeling biological neural networks with a specific emphasis on modeling brain structures and functions, implementation of the teachings recited herein are not limited to modeling any particular environment. Rather, embodiments of the invention are capable of being implemented in conjunction with any other type of environment, for example, weather patterns, arbitrary data collected from the internet, etcetera, as long as the various inputs to the environment can be turned into a vector.

Although this detailed description describes various aspects of computer system architectures, for ease of reference and explanation some features and/or functionality of the disclosed computer system architecture are described using neurological terminology such as neurons, synapses, spikes, and the like. It will be understood that for any discussion or illustration herein of a computer system architecture, the use of neurological terminology or neurological shorthand notations are for ease of reference and are meant to cover the neural network equivalents of the described neurological function and/or neurological component.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

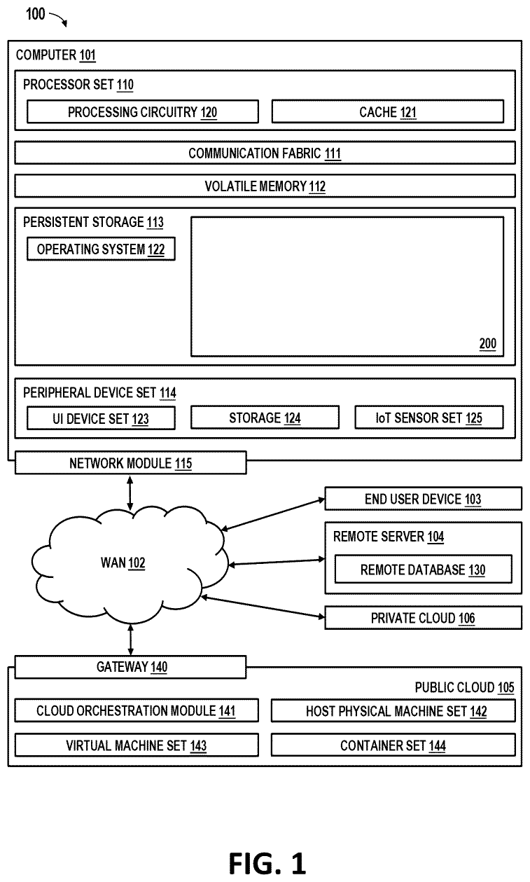

FIG. 1 depicts a computing environment 100 that contains an example of an environment for the execution of at least some of the computer code involved in performing the inventive methods, such as code block 200 operable to perform approximation-free neural network mapping. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In its simplest form, artificial intelligence (AI) is a field that combines computer science and large-scale comprehensive datasets to enable problem-solving. In general, AI refers to the broad category of machines that can mimic human cognitive skills. AI also encompasses the sub-fields of machine learning and deep learning. AI systems can be implemented as AI algorithms that perform as cognitive systems that make predictions or classifications based on input data.

A category of machines that can mimic human cognitive skills is neural networks (NNs). In general, a NN is a network of artificial neurons or nodes inspired by the biological neural networks of the human brain. The artificial neurons/nodes of a NN are organized in layers and typically include input layers, hidden layers and output layers. Neuromorphic and synaptronic systems, which are also referred to as artificial neural networks (ANNs), are computational systems that permit electronic systems to essentially function in a manner analogous to that of biological brains. Neuromorphic and synaptronic systems do not generally utilize the traditional digital model of manipulating zeros (0s) and ones (1s). Instead, neuromorphic and synaptronic systems create connections between processing elements that are roughly functionally equivalent to neurons of a biological brain. Neuromorphic and synaptronic systems can be implemented using various electronic circuits that are modeled on biological neurons.

Spiking neural networks (SNNs) are ANNs that more closely mimic natural or biological neural networks. In addition to neuronal and synaptic state, SNNs incorporate the concept of time into their operating model. Neurons in an SNN transmit information only when a membrane potential, which is an intrinsic quality of the neuron related to its membrane electrical charge, reaches a specific value called the threshold. When the membrane potential reaches the threshold, the neuron fires, thereby generating a signal that travels to other downstream neurons. The transmitted signal increases or decreases the downstream neuron's membrane potential. A neuron model that fires at the moment of threshold crossing is also called a spiking neuron model. Similar to other NNs, the neurons of an SNN are organized into layers that include an input layer, an output layer and one or more hidden layers between the input layer and the output layer.

So-called single-spike SNNs (SS-SNNs) are configured and arranged such that each neuron of each layer spikes at most once. Limiting the number of spikes limits the computational and communication demands at each neuron, which generally improves the computational efficiency of SS-SNNs in comparison to other NNs such as conventional ANNs.

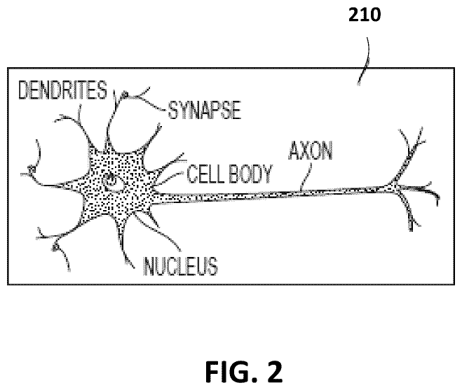

As context for embodiments of the invention described herein, an overview of biological neural networks will now be provided. FIG. 2 depicts a sketch of a biological neuron 210. The biological neuron 210, also known as a nerve cell, is a special biological cell that processes information. As shown, it is composed of a cell body, or soma, and two types of outward reaching, tree-like branches, namely, the axon and the dendrites. The cell body has a nucleus that contains information about hereditary traits and a cytosol that holds the molecular equipment for producing material needed by the neuron. A neuron receives signals (impulses) from other neurons through its dendrites (receivers) and transmits signals generated by its cell body along the axon (transmitter), which eventually branches into strands and sub-strands. At the terminals of these strands are the synapses. A synapse is an elementary structure and functional unit between two neurons (an axon strand of one neuron and a dendrite of another). When the impulse reaches the synapse's terminal, certain chemicals called neurotransmitters are released. The neurotransmitters diffuse across the synaptic gap, to enhance or inhibit, depending on the type of the synapse, the receptor neuron's own tendency to emit electrical impulses. The synapse's efficacy can be adjusted by the signals passing through it so that synapses can learn from the histories of activities in which they participate. This dependence on history acts as a memory, which is possibly responsible for human memory.

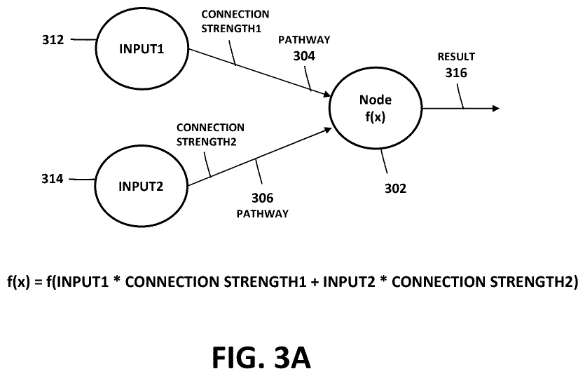

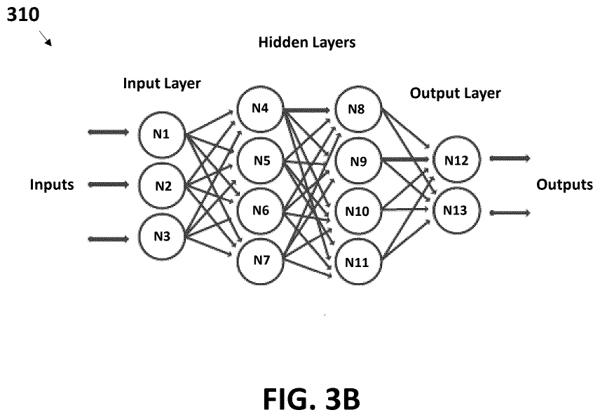

In FIG. 3A, the biological neuron 210 (shown in FIG. 2) is modeled as a node 302 having a mathematical function, f(x), depicted by the equation shown in FIG. 3A. Node 302 receives electrical signals from inputs 312, 314, multiplies each input 312, 314 by the strength of its respective connection pathway 304, 306, takes a sum of the inputs, passes the sum through a function, f(x), and generates a result 316, which may be a final output or an input to another node, or both. In this detailed description, an asterisk (*) is used to represent a multiplication. Under some circumstances, weak input signals are multiplied by a very small connection strength number, so the impact of a weak input signal on the function is very low. Similarly, under some circumstances, strong input signals are multiplied by a higher connection strength number, so the impact of a strong input signal on the function is larger. The function f(x) is a design choice, and a variety of functions can be used. A suitable design choice for f(x) is the hyperbolic tangent function, which takes the function of the previous sum and outputs a number between minus one and plus one.

FIG. 3B depicts a simplified example of a neural network architecture (or model) 310. In some embodiments of the invention, the neural network architecture/model 310 can be a deep learning neural network. In general, neural networks can be implemented as a set of algorithms running on a programmable computer (e.g., computing environment 100 shown in FIG. 1). In some instances, neural networks are implemented on an electronic neuromorphic machine (e.g., a computer chip) that attempts to create connections between processing elements that are substantially the functional equivalent of the synapse connections between brain neurons. In either implementation, neural networks incorporate knowledge from a variety of disciplines, including neurophysiology, cognitive science/psychology, physics (statistical mechanics), control theory, computer science, artificial intelligence, statistics/mathematics, pattern recognition, computer vision, parallel processing and hardware (e.g., digital/analog/VLSI/optical). The basic function of a neural network is to recognize patterns by interpreting sensory data through a kind of machine perception. Real-world data in its native form (e.g., images, sound, text, or time series data) is converted to a numerical form (e.g., a vector having magnitude and direction) that can be understood and manipulated by a computer. The neural network is “trained” by performing multiple iterations of learning-based analysis on the real-world data vectors until patterns (or relationships) contained in the real-world data vectors are uncovered and learned.

Neural networks use feature extraction techniques to reduce the number of resources required to describe a large set of data. The analysis on complex data can increase in difficulty as the number of variables involved increases. Analyzing a large number of variables generally requires a large amount of memory and computation power. Additionally, having a large number of variables can also cause a classification algorithm to over-fit to training samples and generalize poorly to new samples. Feature extraction is a general term for methods of constructing combinations of the variables in order to work around these problems while still describing the data with sufficient accuracy.

Although the patterns uncovered/learned by a neural network can be used to perform a variety of tasks, two of the more common tasks are labeling (or classification) of real-world data and determining the similarity between segments of real-world data. Classification tasks often depend on the use of labeled datasets to train the neural network to recognize the correlation between labels and data. This is known as supervised learning. Examples of classification tasks include identifying objects in images (e.g., stop signs, pedestrians, lane markers, etc.), recognizing gestures in video, detecting voices, detecting voices in audio, identifying particular speakers, transcribing speech into text, the like. Similarity tasks apply similarity techniques and (optionally) confidence levels (CLs) to determine a numerical representation of the similarity between a pair of items.

Referring again to FIG. 3B, the neural network architecture/model 310 is organized as a weighted directed graph, wherein the artificial neurons are nodes (e.g., N1-N13), and wherein weighted directed edges (i.e., directional arrows) connect the nodes. The neural network architecture/model 310 is organized such that nodes N1, N2, N3 are input layer nodes, nodes N4, N5, N6, N7 are first hidden layer nodes, nodes N8, N9, N10, N11 are second hidden layer nodes, and nodes N12, N13 are output layer nodes. The use of multiple hidden layers indicates that the neural network architecture/model 310 is a deep learning neural network architecture/model. Each node is connected to every node in the adjacent layer by connection pathways, which are depicted in FIG. 3B as directional arrows each having its own connection strength. For ease of illustration and explanation, one input layer, two hidden layers, and one output layer are shown in FIG. 3B. However, in practice, multiple input layers, multiple hidden layers, and multiple output layers can be provided.

Each input layer node N1, N2, N3 of the neural network 310 receives Inputs directly from a source (not shown) with no connection strength adjustments and no node summations. Each of the input layer nodes N1, N2, N3 applies its own internal f(x). Each of the first hidden layer nodes N4, N5, N6, N7 receives its inputs from all input layer nodes N1, N2, N3 according to the connection strengths associated with the relevant connection pathways. Thus, in first hidden layer node N4, its function is a weighted sum of the functions applied at input layer nodes N1, N2, N3, where the weight is the connection strength of the associated pathway into the first hidden layer node N4. A similar connection strength multiplication and node summation is performed for the remaining first hidden layer nodes N5, N6, N7, the second hidden layer nodes N8, N9, N10, N11, and the output layer nodes N12, N13.

The neural network architecture/model 310 (or ANN 310) can be implemented to include various connection patterns or architectures. Based on the connection pattern, ANNs can be grouped into two general categories, namely, feed-forward networks in which graphs have no loops, and feed-back or recurrent networks in which loops occur because of feed-back connections. In the most common family of feed-forward networks, known generally as multilayer perceptron networks, neurons are organized into layers that have unidirectional connections between them.

Different connectivity in ANNs yields different network behaviors. In general, feed-forward networks are static. In other words, they produce only one set of output values rather than a sequence of values from a given input. Feed-forward network dynamics are memory-less in the sense that their response to an input is independent of the previous network state (though their weights may hold history-dependent state). By contrast, feed-back or recurrent networks are dynamic systems. When a new input pattern is presented, the neuron outputs are computed. Because of the feed-back paths, the signals can travel in both directions using loops. All possible connections between neurons are allowed. Because loops are present in this type of network, under certain operations, it can become a non-linear dynamical system that changes continuously until it reaches a state of equilibrium. Feed-back networks are often used in associative memories and optimization problems where the network looks for the best arrangement of interconnected factors.

The neural network architecture/model 310 (or ANN 310) can implement various deep learning-based feature extraction and classification methods. In general, deep learning-based classification schemes have two sub-networks, a feature extraction network followed by a classification sub-network, and the two networks are learned jointly during training. Different network architectures require appropriate learning algorithms. The ability to learn is a fundamental trait of intelligence. A learning process in the ANN context can be viewed as the problem of updating network architecture and connection weights so that a network can efficiently perform a specific task. The network usually must learn the connection weights from available training patterns. Performance is improved over time by iteratively updating the weights in the network. An ANNs' ability to automatically learn from examples makes it an attractive design option. Instead of following a set of rules specified by human experts, ANNs appear to learn underlying rules (like input-output relationships) from the given collection of representative examples. This is one of the major benefits of ANNs over traditional expert systems.

In order to understand or design a learning process, it is necessary to have a model of the environment in which a neural network operates. In other words, the information that is available to the network must be known. This model may be referred to as a learning paradigm. Additionally, it must be understood how network weights are updated. In other words, the learning rules that govern the updating process must be understood. A learning algorithm refers to a procedure in which learning rules are used for adjusting the weights. There are three main learning paradigms: supervised, unsupervised, and hybrid. In supervised learning, or learning with a “teacher,” the network is provided with a correct answer (output) for every input pattern. Weights are determined to allow the network to produce answers as close as possible to the known correct answers. Reinforcement learning is a variant of supervised learning in which the network is provided with only a critique on the correctness of network outputs, not the correct answers themselves. In contrast, unsupervised learning, or learning without a teacher, does not require a correct answer associated with each input pattern in the training data set. It explores the underlying structure in the data, or correlations between patterns in the data, and organizes patterns into categories from these correlations. Hybrid learning combines supervised and unsupervised learning. Parts of the weights are usually determined through supervised learning, while the others are obtained through unsupervised learning.

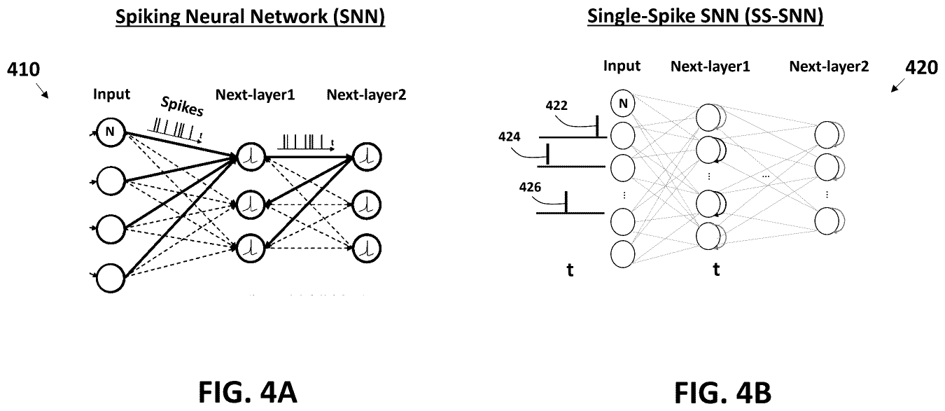

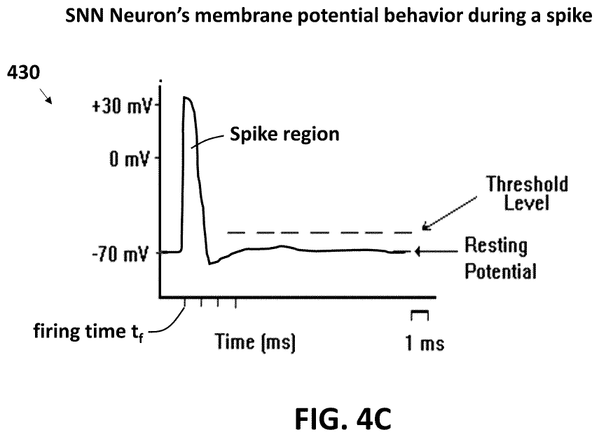

FIG. 4A depicts a simplified block diagram illustrating a general architecture of spiking neural network (SNN) 410 operable to be utilized in implementing aspects of the invention. As shown, the SNN 410 includes a network of artificial neurons or nodes (one of which is labeled N in FIG. 4A) organized as Input layer(s), Next-layer1, and Next-layer2. In some instances, Next-layer1 and Next-layer2 can both be hidden layer(s). In some instances, Next-layer1 and Next-layer2 can be hidden layer(s) and output layer(s). Despite being similar to one another, artificial neurons do not actually mimic the behavior of the biological neurons. Thus, biological and artificial NNs are fundamentally different in general structure, neural computations, and learning rule compared to the brain. In general, a difference between a traditional ANN and a traditional SNN is the information propagation approach. SNNs in general attempt to more closely mimic a biological neural network. For example, instead of communicating analog values used in standard ANNs, SNNs communicate binary values (spikes) at certain points in time. Thus, SNNs are examples of temporal-coding based neural networks (NNs) as opposed to analog-signal-based neural networks (NNs).

SNN models are typically built using mathematical equations that describe the behavior of spiking neurons. These equations take into account various factors such as the input current, membrane potential, and membrane time constant, to simulate the behavior of biological neurons. Each SNN model has its own set of equations that determine its behavior, and several standard model types have been developed, including, for example, leaky integrate-and-fire (LIF), non-leaky integrate-and-fire (NLIF), adaptive exponential integrate-and-fire (AdEx), and the like. Each of these SNN models is implemented using the update method, which takes an input current and a time step and returns whether a spike has occurred or not. The update method uses the equations that describe the behavior of the spiking neurons to calculate the membrane potential of each neuron at each time step. If the membrane potential exceeds a certain threshold, a spike is generated and propagated to the next neurons.

FIG. 4C depicts an example of a SNN neuron's membrane potential behavior during a spike. As shown, SNNs receive a series of spikes as input and produce a series of spikes as the output. A series of spikes is usually referred to as a spike train. The general concept of a “spike” is depicted by the graph 430 shown in FIG. 4C and described as follows. At every moment of time each SNN neuron has some value that is analogous to the electrical potential of biological neurons; the value in an SNN neuron can change based on the mathematical model of the SNN neuron, for example, if the SNN neuron receives a spike from the upstream SNN neuron, the value might increase or decrease; if the value in an SNN neuron exceeds some threshold, the SNN neuron will send a single impulse (shown in FIG. 4C as the “Spike region”) to each downstream SNN neuron connected to the initial one; and, after this, the value of the SNN neuron will instantly drop below its average. Thus, the SNN neuron will experience the analog of a biological neuron's refractory period. Over time, the value of the SNN neuron will smoothly return to its average (or resting potential). The moment of threshold crossing defines the firing time t (f). The SNN model shown in FIG. 4C makes use of the fact that spikes of a given neuron always have roughly the same form. If the shape of a spike is always the same, then the shape cannot be used to transmit information. Instead, information is contained in the presence or absence of a spike. Therefore, spikes are reduced to “events” that happen at a precise moment in time. Neuron models where action potentials are described as events are called “integrate-and-fire” (IF) models. IF models have two separate components that are both necessary to define their dynamics-first, an equation that describes the evolution of the membrane potential v (t); and second, a mechanism to generate spikes.

FIG. 4B depicts a simplified block diagram illustrating a general architecture of a single-spike neural network (SS-SNN) 420 operable to be utilized in implementing aspects of the invention. In general, neural encoding is the study of how neurons represent information by electrical signals (action potentials) at the level of individual cells or in networks of neurons. Network performance is improved by using relatively fast information encoding methods, which enable very fast information processing by the network. At least in some NN systems, the efficient processing of information is more likely to be based on the precise timing of action potential (temporal coding). Single-spike temporal coding denotes that each neuron spikes at most once and more salient information is encoded with earlier spikes (e.g., single-spikes 424, 426 shown in FIG. 4B) over later spikes (e.g., single-spike 422 shown in FIG. 4B).

Thus, SNNs (e.g., SNN 410 shown in FIG. 4A and/or SS-SNN 420 shown in FIG. 4B) represent special classes of NNs, where neuron models communicate by sequences of spikes that align better with the principles of the brain's operation to better understand and implement concepts leading to sustainable AI. Because the technology for using and implementing ANNs is more developed than the technology for using and implementing SNNs, there exists a significant library of pre-trained ANNs that have strong performance track records for multiple task types. However, there are technical benefits and effects of SNNs over ANNs, including, but not limited to the fact that SNNs, and particularly SS-SNNs, can be implemented in a manner that controls the number of spikes. Controlling and/or reducing the number of spikes also controls and/or reduces the computational demands at each SNN neuron, which generally improves the computational efficiency of SS-SNNs in comparison to conventional ANNs. Additionally technical benefits of SNNs include the fact that SNNs are dynamic, which allows them to excel at working with dynamic processes such as speech and dynamic image recognition; an SNN can still train when it is already working; SNNs usually have fewer neurons than the traditional ANNs; SNNs can, potentially, work very fast because the neuron models send impulses instead of a continuous value; and SNNs have increased productivity of information processing and noise immunity over ANNs because SNNs use the temporal presentation of information. The computational efficiency of SNNs, and particularly SS-SNNs, over ANNs enable SNNs to use local processor resources to perform tasks that would, if performed by an ANN, mandate larger processor resources that in many cases cannot be provided locally and are typically only available through accessing remote servers or cloud computing processor resources.

Although SNNs offer solutions to a broad range of specific problems in applied engineering, including, for example, classification problems, there are challenges in realizing the benefits of SNNs. For example, there is a lack of effective and well-established learning methods developed specifically for SNN training. The specifics of SNN operations do not allow data scientists to effectively use traditional learning methods, for example, gradient descent. There are unsupervised biological learning methods that can be used to train an SNN; however, such methods are time-consuming and do not match the speed and learning performance of traditional ANN learning techniques applied to ANNs. Additionally, when using SNNs for real-world applications, the SNN's overall performance will be impacted by two metrics, namely task accuracy (e.g., classification accuracy) and task latency (e.g., classification latency). In general, a model's task accuracy is the fraction of total predictions made by the model that are correct. The percentage of correct predictions for a model can be determined in a variety of ways. For example, the task accuracy for a prediction model can be computed as the total number of correct predictions divided by the total number of predictions. In general, a model's task latency is a measurement to determine the performance of a model for carrying out its task (e.g., a classification task). Latency refers to the time taken to process one unit of data provided only one unit of data is processed at a time. The unit of latency is seconds (time unit). In terms of image classification tasks, latency is the time taken to process one image for batch size one (1). Batch size is the number of images processed at a time together. For example, Model-A is trained for image classification and takes 0.057 seconds to classify one image. In comparison, Model-B is trained for image classification and takes 0.009 seconds to classify the same image. Thus, stated more generally, latency is the time a user has to wait to receive the task result. If the waiting time is observable, it provides a poor user experience. It is generally a desired performance features for NN systems to work in real time and hence, it is important to improve latency. In general, known SNN-based systems do not provide adequate control and or management of an SNN-based (and/or SS-SNN-based) system's task accuracy and task latency.

Embodiments of the invention described herein provide SNN-based (and/or SS-SNN-based) systems operable to take advantage of the relatively large library of trained well-functioning ANNs for a variety of tasks, and further operable to take advantage of the previously-described advantages of relatively sparse and processor resource efficient SNNs and/or SS-SNNs, by identifying a suitable trained ANN for a given task and creating a corresponding SS-SNN for the given task. Embodiments of the invention create the corresponding SS-SNN by mapping the learning built into the trained ANN to the corresponding SS-SNN, thereby creating an SS-SNN operable to provide the same performance level on the given task as the ANN but without requiring the same processor resources required by the ANN. In some embodiments of the invention, the starting or map-source ANN is fully trained for the given task. In some embodiments of the invention, the map-source ANN is fully trained for a task that is different from but close to the given task, such that the map-source ANN is actually a map-source1 ANN that acts as a foundation model from which the desired or map-source2 ANN model can be created. In general, foundation models are AI models designed to produce a wide and general variety of outputs. They are capable of a range of possible tasks and applications, such as text, image or audio generation. They can be standalone systems or can be used as a “base” for many other applications.

In embodiments of the invention, the previously-described mapping is performed using a mapping functionality operable to, from a “source” ANN solution, obtain a “target” SNN solution that for equivalent input data produces equivalent output data. The mapping functionality performed in accordance with embodiments of the invention is referred to herein as approximation-free in that the target SNN solution has prediction performance that is substantially equivalent to the prediction performance of the source ANN solution. In some embodiments of the invention, the mapping functionality is operable to, from an ANN solution with rectified linear units (ReLUs) and optional convolutions and optional batch normalizations, obtain an SNN solution with single-spike coding and piecewise linear neuronal dynamics with specific time intervals that for equivalent input data produces equivalent output data. In general, a ReLU is an activation function that introduces the property of non-linearity to a deep learning model and solves the vanishing gradients issue. The output of the activation function is also called activation. In some embodiments of the invention, the mapping functionality includes a two-step mapping, where the first mapping is from an original ANN architecture and parameters (i.e., ANN components) to an intermediate or scaled ANN architecture and parameters (i.e., scaled ANN components). The first mapping includes transformation of input and output coding and transformation of the network structure of the original ANN architecture and parameters to create the scaled ANN architecture and parameters, which is equivalent to the original ANN architecture and parameters. The second mapping converts the scaled ANN architecture and parameters to its equivalent form of an SNN architecture and parameters (i.e., SNN components), which is the SNN solution.

In some embodiments of the invention, the pre-trained ANN has equivalent performance to the converted SNN in that the SNN has been configured to include specific neuronal dynamics that depend from and are based on parameters of the pre-trained ANN. In other words, the specific calculations inside the SNN neurons (the neuronal dynamics) cannot be arbitrary, but are instead defined according to criteria that depends on parameters and/or architectural features of the pre-trained ANN. For example, the pre-trained ANN parameters can include weights and/or biases, which determine the strength of connections between neurons in the pre-trained ANN. These parameters from the pre-trained ANN can be used to compute the parameters of the converted SNN. Thus, embodiments of the invention achieve operational equivalency between the pre-trained ANN and the converted SNN by using the pre-trained ANN parameters to calculate all of the parameters that are necessary for the converted SNN to generate outputs. Accordingly, it can be mathematically proven that these two networks (the pre-trained ANN and the converted SNN) are equivalent, and the same outputs generated by one of the two networks can be generated by the other network. Thus, the SNN created using embodiments of the invention delivers performance that is substantially equivalent to the performance of the pre-trained ANN from which the converted SNN was derived, which enables ANN performance to be achieved with the computational efficiency of SNNs and without the computational expense of ANNs.

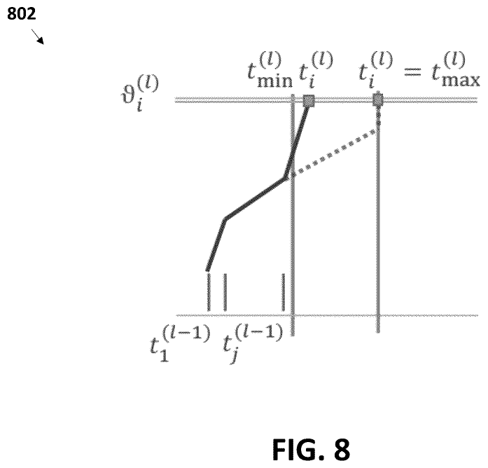

Embodiments of the invention use preprocessing operations to normalize or scale the ANN parameters and architecture, and then use conversion operations to convert the scaled/normalized ANN architecture and parameters to the architecture and parameters that will be used in the converted SNN. In the preprocessing operations, the pre-trained ANN architecture includes a configuration of different layers, which can include, for example, fully connected layers, convolutional layers, max pooling layers, and the like. The preprocessing operations fuse certain of the pre-trained ANN layers to reduce the number of layers that need to be converted. However, because the resulting SNN will need to be equivalent to the pretrained ANN, layer fusion is applied only to layers in the pretrained ANN that can be fused while maintaining functional equivalence with the pre-fused layers. The preprocessing operations further include scaling or normalizing the weights of the pretrained ANN. The weights in the pretrained ANN determine or define how strong the neuronal connections are, and in this portion of the preprocessing operations, the input weights and the output weights of each neuron are scaled or normalized, which provides uniformity to the subsequent conversion operations. Additionally, the preprocessing operations further include computing the maximum output (Xₙ) (e.g., maximum activation output) of each layer of the pretrained ANN so that this maximum layer output (e.g., maximum layer activation output) value can be used to set a maximum size of a spiking window provided in the converted SNN in accordance with aspects of the invention (as shown in FIGS. 8, 9, and 10). In the conversion operations, the spiking interval of each SNN layer is configured and arranged to create a tₘₐₓ value that sets a maximum value of the spiking interval to make sure that the spiking interval is large enough to perform the operations converted to the SNN from the pretrained ANN.

The approximation-free mapping operations described herein can be applied to variety of types of source NNs and target NNs. For example, the source NN can include a variety of types of pre-trained analog-signal-based NNs; and the target NN can include a variety of types of temporal-coding-based NN. In some embodiments of the invention, the pre-trained analog-signal-based NNs includes ANNs. In some embodiments of the invention, the temporal-coding-based NNs include an SS-NN. In some embodiments of the invention, the temporal-coding-based NNs include an SNN.

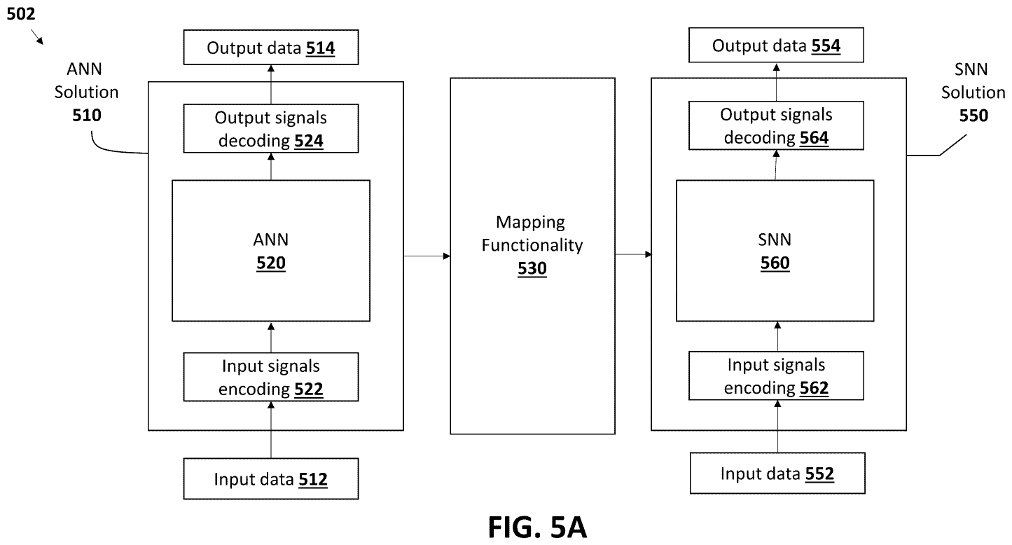

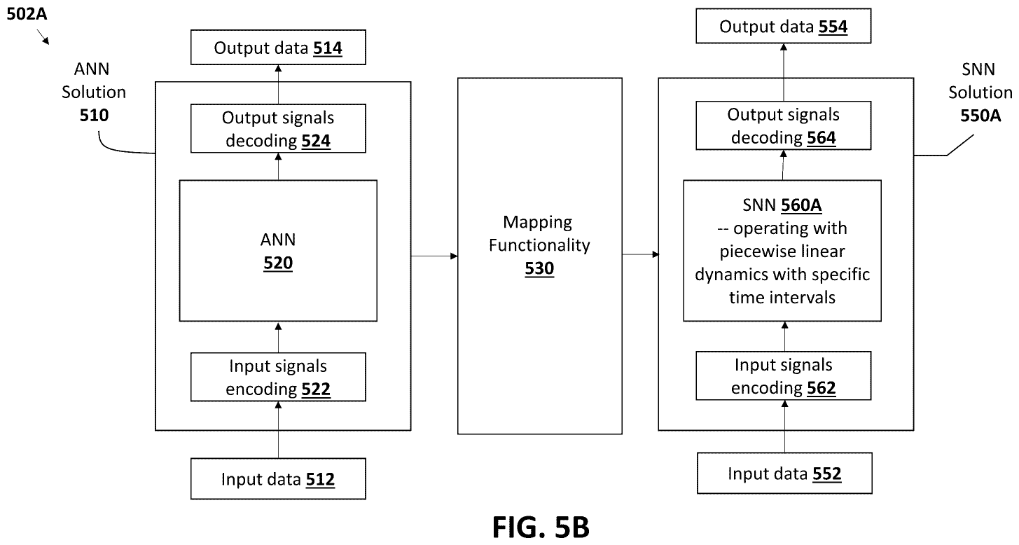

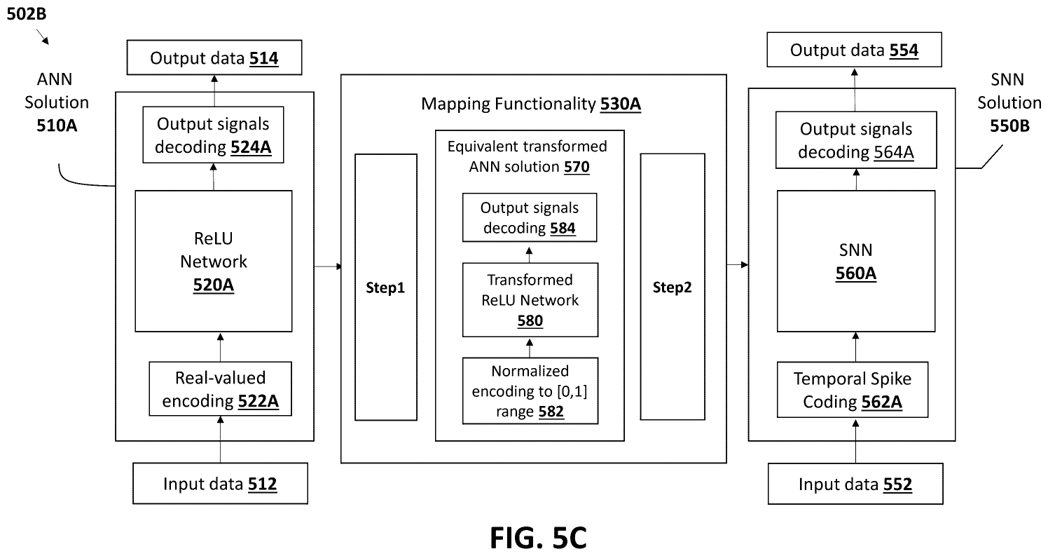

Turning now to a more detailed description of aspects of the invention, FIG. 5A depicts a simplified block diagram of a system 502 operable to map or convert an ANN solution 510 to an SNN solution 550 using a novel mapping functionality 530. As shown in FIG. 5A, the ANN solution 510 is operable to receive input data 512, perform an ANN task (e.g., using an ANN 520), and generate in response to the input data 512 the output data 514. Within the ANN solution 510, the input data 512 is encoded using input signal encoding 522 then passed through the ANN 520. For input signal encoding 522, the raw input data values are encoded to a numerical representation supported by the ANN 520, which can involve representing input data in some binary format, such as a vector or a floating-point number e.g., with 32-bit precision, or any other representation (e.g., fixed-point, integer) and precision. Output signal decoding 524 decodes outputs from the ANN 520 to generate the output data 514. The output signal decoding 524 decodes output values from the model to the expected output representation, complementarily to the input signal encoding 522. The novel mapping functionality 530, in accordance with aspects of the invention, is used to take the learned parameters of the ANN 520 and maps or converts the learned parameters of the ANN 520 to SNN parameters that can be applied to the SNN solution 550. The SNN solution 550 is operable to receive input data 552, perform an SNN task (e.g., using an SNN 560), and generate in response to the input data 552 the output data 554. Within the SNN solution 550, the input data 552 is encoded using input signal encoding 562 then passed through the SNN 560. For the input signal encoding 562, the raw input data values are encoded to a temporal representation supported by the SNN 560, which can involve generating spikes with timings encoding the raw input data values. Output signal decoding 564 decodes outputs from the SNN 560 to generate the output data 554. For the output signal decoding 564, the output values from the model are decoded to the expected output representation, complementarily to the input signal encoding 562. Based on the particular SNN implementation, the last layer may emit spikes whose timings can be decoded to obtain the output values. Alternatively, the last SNN layer can be implemented differently than the rest of the SNN. For example, in the image classification example used herein, the output layer implements neurons that only integrate and do not spike. The output values are then decoded from the final membrane potentials of these neurons.

FIG. 5B depicts a simplified block diagram of a system 502A, which is a non-limiting example of how the system 502 (shown in FIG. 5A) can be implemented in accordance with some embodiments of the invention. The system 502A is substantially the same as the system 502 except the system 502A depicts an SNN solution 550A. The SNN solution 550A is substantially the same as the SNN solution 550 (shown in FIG. 5A) except the SNN 560 (shown in FIG. 5A) of the SNN solution 550 is implemented in the SNN solution 550A as SNN 560A, which is configured and arranged to operate with piecewise liner dynamics with specific time intervals. Additional details of SNN 560A are provided in connection with descriptions of FIGS. 5C, 6A, 6B, 7A, and 7C provided subsequently herein.

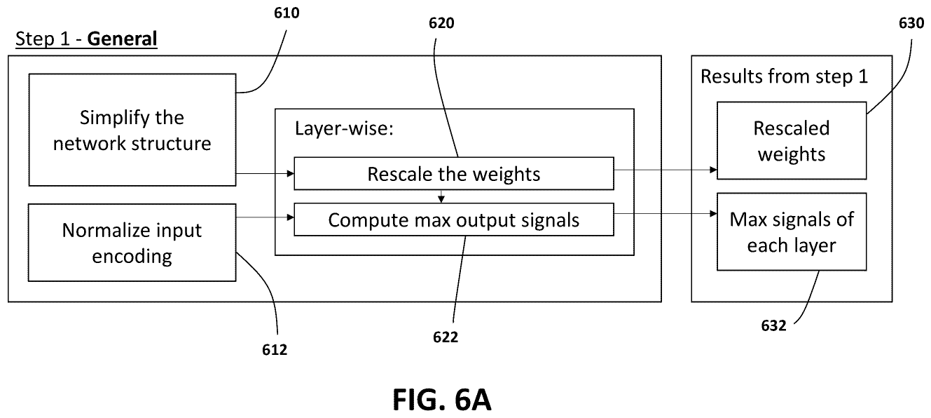

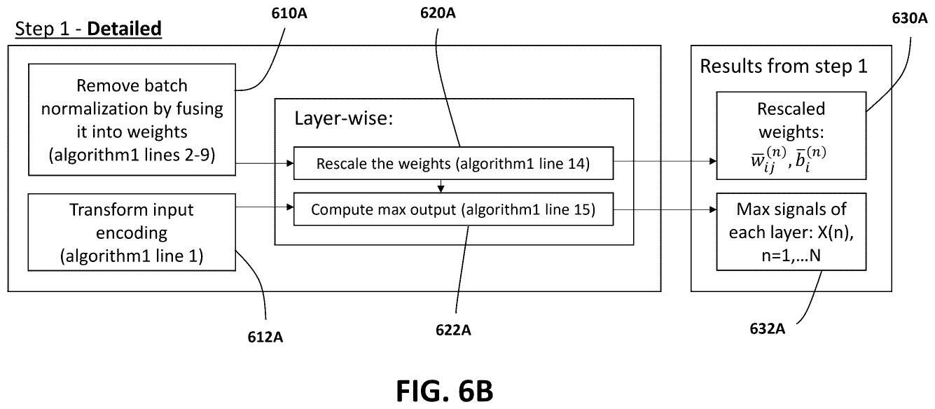

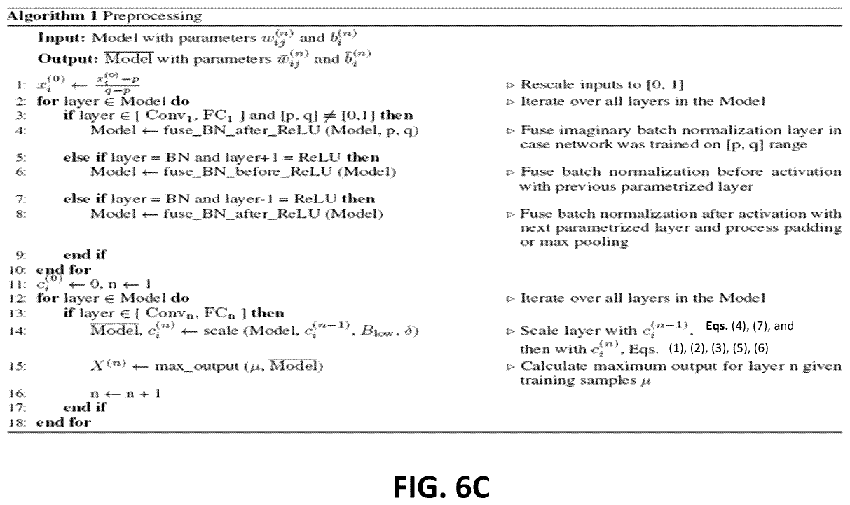

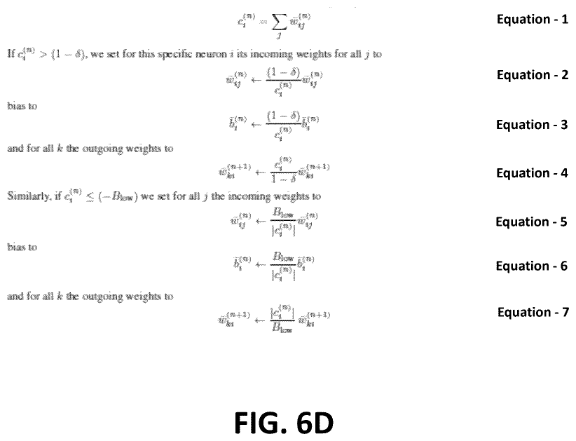

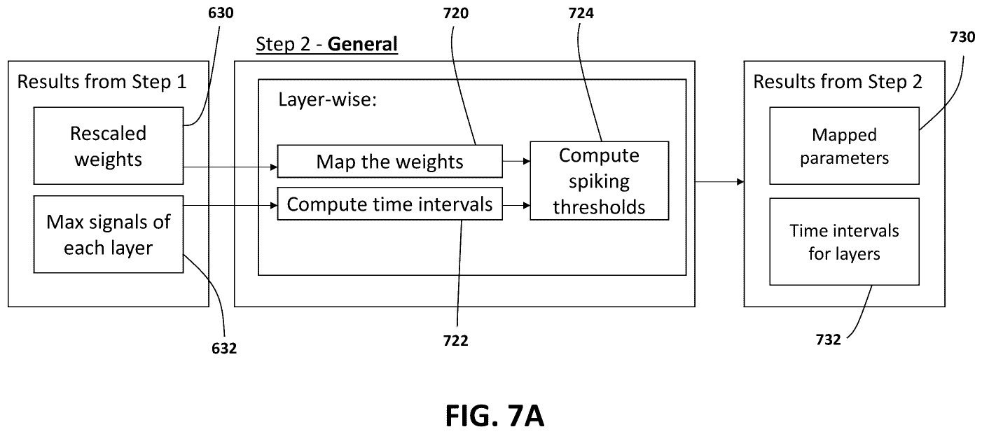

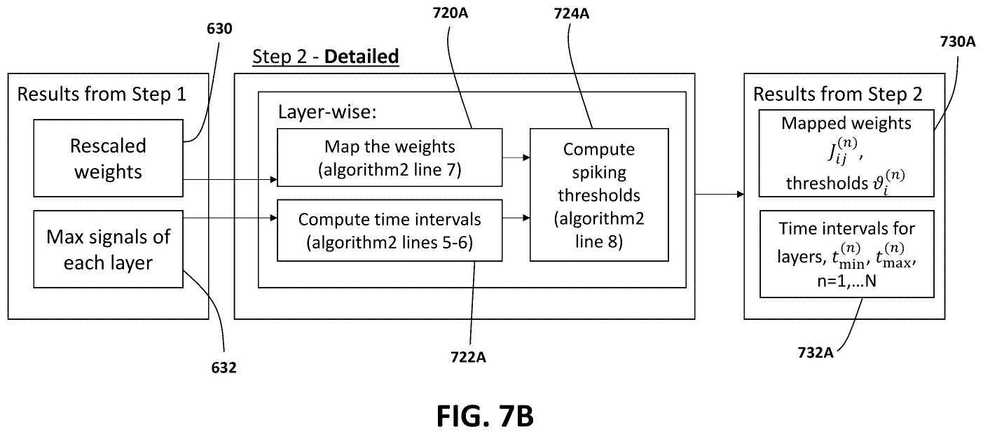

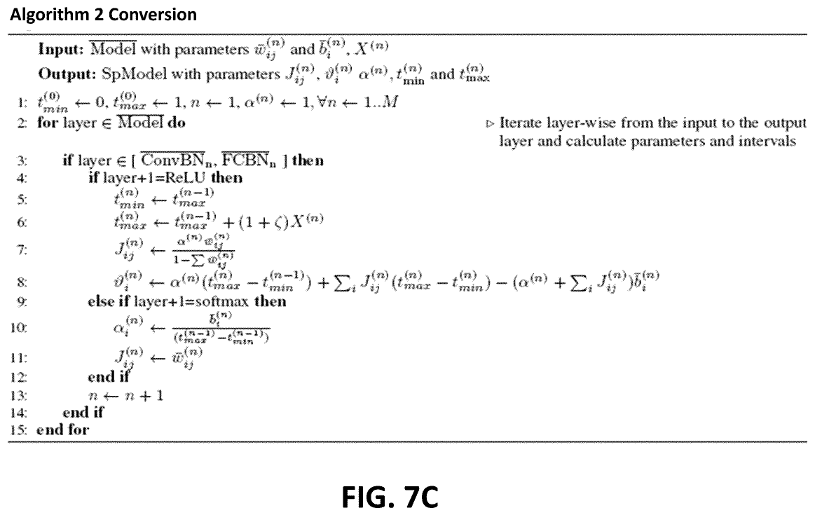

FIG. 5C depicts a simplified block diagram of a system 502B, which is a non-limiting example of how the system 502A (shown in FIG. 5B) can be implemented in accordance with some embodiments of the invention. The system 502B is substantially the same as the system 502A except the system 502B depicts an ANN solution 510A, a novel mapping functionality 530A, and an SNN solution 550B. The ANN solution 510A is identical to the ANN solution 510 (shown in FIG. 5B) except the ANN solution 510A includes real-valued encoding 522A (i.e., the inputs are coded into floating or fixed-point number representation), an ReLU network 520A, and output signals decoding 524A, configured and arranged as shown. The SNN solution 550B is substantially the same as the SNN solution 550A (shown in FIG. 5B) except the SNN solution 550B includes a temporal spike coding 562A, the SNN 560A, and output signal decoding 564A, configured and arranged as shown. In a temporal spike coding 562A, more salient information is encoded with earlier spikes. The novel mapping functionality 530A includes a Step1 function that leads to an equivalent transformed ANN solution 570 that leads to a Step2 function. The equivalent transformed ANN solution 570 includes normalized encoding 582 to the [0, 1] range provided to a transformed ReLU network 580, which is coupled to output signals decoding 584. Without limiting the generality of the approach, the ranges are mapped to range [0,1] for convenience of subsequent mathematical derivations. This is a preprocessing step illustrated in FIG. 6C, line 1. Such a normalization and choice of the [0,1] range are preprocessing operations used in deep learning techniques. The novel mapping functionality 530A utilizes a two-step mapping that includes transformation of input and output coding and transformation of the network structure, where the first step (Step1) results in an equivalent transformed ANN solution 570, and the second step (Step2) results in the SNN solution 550B. Additional details of the system 502B are provided subsequently herein in connection with descriptions of FIGS. 6A, 6B, 6C, 7A, 7B, and 7C.

FIG. 6A depicts a simplified block diagram illustrating a non-limiting example of how Step1 of the novel mapping functionality 530A can be implemented in accordance with some embodiments of the invention. FIG. 6B depicts additional details of how Step 1 shown in FIG. 6A can be implemented in accordance with some embodiments of the invention; and FIGS. 6C and 6D depict additional details of an algorithm (Algorithm 1 preprocessing) and equations (Equations 1-7) that can be used to implement Step 1 as shown in FIGS. 6A and 6B. As shown, in FIG. 6A, Step1 can be implemented by performing operations depicted at blocks 610, 612, 620, 622, thereby generating the results from Step1, which are depicted at blocks 630, 632. In FIG. 6B, Step1 can be implemented by performing operations depicted at blocks 610A, 612A, 620A, 622A, thereby generating the results from Step1, which are depicted at blocks 630A, 632A. Referring now to FIGS. 6A and 6B, at block 610, 610A, Step1 simplifies the network structure of the ReLU network 520A, and at block 612, Step1 normalizes the input encodings of the ReLU network 520A. If the inputs to Step1 from the ReLU network 520A are not in the [0, 1] range, they will be normalized to this range (e.g., using line 1 of Algorithm 1 shown in FIG. 6C). In addition, the network structure of the ReLU network 520A is simplified (e.g., using lines 2-8 of Algorithm 1 shown in FIG. 6C). The outputs of block 610, 610A are provided to block 620, 620A; and the outputs of block 612, 612A are provided to block 622, 622A. Blocks 620, 620A, 622, 622A iterate layer-wise through all of the simplified layers from the inputs to the outputs of the simplified layers of the ReLU network 520A, and, in each layer, the input weights are scaled and then the output weights are scaled (e.g., using line 14 of Algorithm 1 shown in FIG. 6C). After the scaling at block 620, 620A is done, block 622, 622A computes the maximum output of this layer for a sample of training data (e.g., using line 15 of Algorithm 1 shown in FIG. 6C). The result of the Step1 is the transformed ANN solution 570 (shown in FIG. 5C) with rescaled weights (block 630, 630A), along with the maximum output value for signals of each layer (block 632, 632A).

With respect to the additional features depicted in FIG. 6B, the ANN network (represented by the ReLU network 520A) can be simplified by detecting all batch normalization layers (or batch normalization operations) in the network and fusing them with either previous or following parameterized layers (fully-connected or convolutional layer) (see lines 2-8 of Algorithm 1 shown in FIG. 6C). Particularly, if the input was not originally on the [0, 1] range, an “imaginary” batch normalization layer will be fused with the first parametrized layer (e.g., line 4 in Algorithm 1 shown in FIG. 6C). Batch normalization is a deep learning technique of normalizing data per batch “layer” of a network (i.e., stages of processing).

In FIG. 7A, the results (630, 632) of Step1 are provided to Step 2. Step 2 can be implemented using blocks 720, 722, 724 shown in FIG. 7A, and additional detail of how Step 2 can be implemented are depicted at blocks 720A, 722A, 724A of FIG. 7B. The operations at Step 2 generate results from Step 2, which are depicted at blocks 730, 732, 730A, 732A shown in FIGS. 7A and 7B. In FIGS. 7A and 7B, the results of the previous Step 1 (rescaled weights 630 and the maximum output/signal value for each ANN layer 632) are fed into the Step 2, which performs mapping to the parameters of the SNN 560A. For each hidden layer in the SNN 560A (layers with ReLU activation in the ANN), the weights of that layer will be calculated as given in line 7 of Algorithm 2 (shown in FIG. 7C). In addition, the time interval in which this layer will be allowed to spike is determined (see lines 5-6 in Algorithm 2 shown in FIG. 7C). After obtaining these variables, the value of firing threshold of each neuron in the current layer is calculated (see line 8 in Algorithm 2.). The output of Step 2 is an SNN 560A (shown in FIGS. 5A, 5B) with mapped parameters 730, 730A and time intervals 732, 732A in which the neurons of the SNN 560A will spike. In addition, for the output layer in the SNN solution 550A, parameters are set in a different way (compared to the hidden layers) as given in lines 10-11 of the Algorithm 2 shown in FIG. 7C.

It should be noted that various algorithms, equations and text explanations are provided in the figures of this detailed description, including the algorithm code lines, equations and text explanations provided in FIGS. 6C, 6D, 7C, 8, 9, and 10. These algorithm code lines, equations and text explanations provide non-limiting examples of how embodiments of the invention can be implemented. The specific details of the algorithm code lines equations are non-limiting examples and can be understood by persons skilled in the relevant arts. Thus, additional details about the algorithm code lines and equations and text explanations are not provided in the interest of brevity.

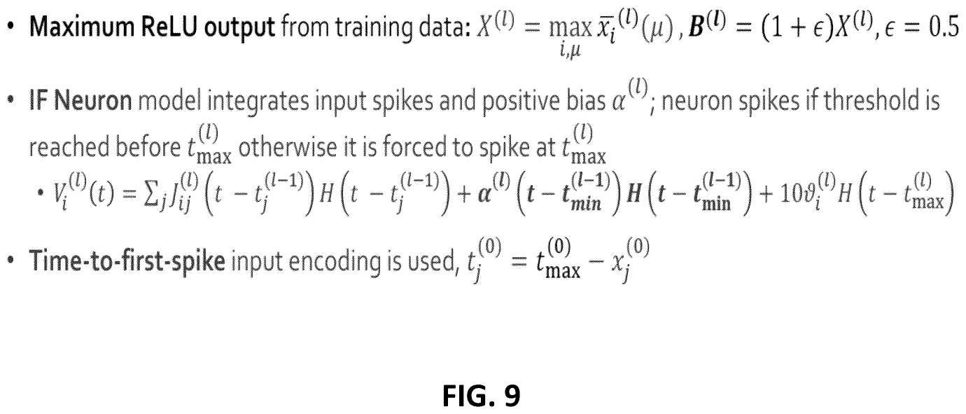

FIG. 8 depicts a graph or plot 802 that illustrates the integrate-and-fire (IF) dynamics of a spiking neuron in accordance with aspects of the invention. The observed neuron receives spikes from the previous layer and changes its membrane potential. Once the membrane potential reaches the threshold (e.g., the Threshold Level shown in FIG. 4C), the spike is generated and sent to the neurons in the next layer. If the spike hasn't been generated before the end of the spiking interval tₘₐₓ, it will be forced at this time instant. FIG. 9 describes additional details of the graph or plot 802 shown in FIG. 8 and also shows a formula of how membrane potential evolves over time. FIG. 9 shows that time-to-first spike input encoding is used in some embodiments.

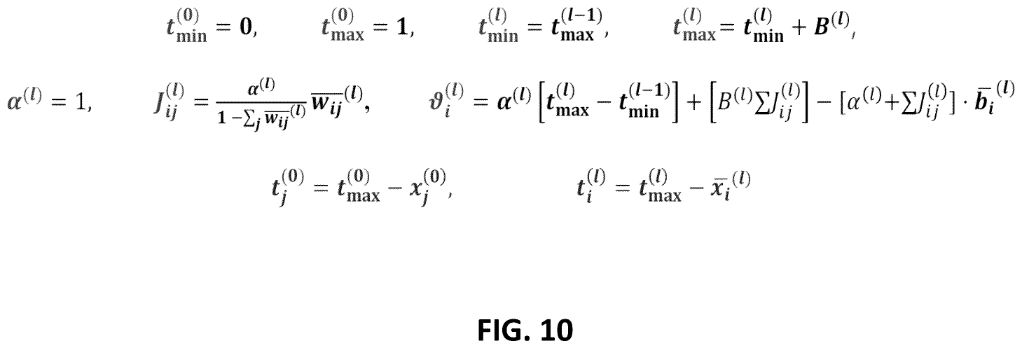

FIG. 10 depicts equations illustrating how mapping functionality can be implemented in accordance with aspects of the invention. The provided formulas show how to calculate weights of the SNN (Jᵢⱼ), time intervals (tₘₐₓ) and the value of firing the threshold of each neuron (ϑᵢ). These choices guarantee that the spiking time tᵢ of SNN neurons and the output of the corresponding ReLU (xᵢ) in the scaled network can be derived from each other via linear relationships as given in FIG. 10 (bottom equations).

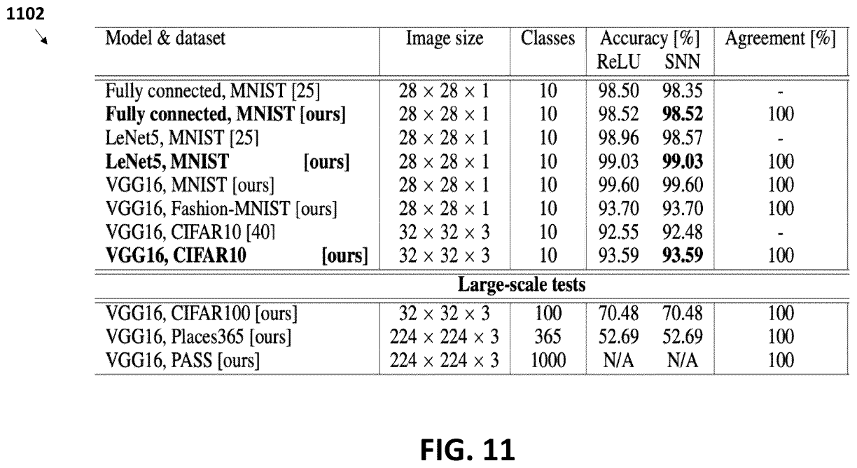

FIG. 11 depicts a table 1102 illustrating the results of tests performed to confirm that the SNN solution 550A, 550B (shown in FIGS. 5B, 5C) has prediction performance that is substantially equivalent to the prediction performance of the ANN solution 510, 510A, which means that the SNN solution 550A, 550B is approximation-free with respect to the ANN solution 510, 510A As shown in FIG. 11, for all deep architectures, the accuracy of the ANN solution 510, 510A is the same as the accuracy of the SNN solution 550A, 550B as the two networks are equivalent, and the accuracy of the SNN solution 550A, 550B was achieved by performing techniques described herein without needing any fine tuning or additional training of the SNN solution 550A, 550B. The Agreement metric shows percentage of inputs for which original ReLU network and SNN network predict the same class and is always 100%. The mapped parameters generated in accordance with aspects of the invention ensure a mathematical equivalence between the ANN solution 510, 510A and the SNN solution 550A, 550B, where the activation of a certain neuron in the ANN solution 510, 510A can be recovered from the spiking time of the corresponding neuron in the SNN solution 550A, 550B. The mathematical equivalence between the ANN solution 510, 510A and SNN solution 550A, 550B guarantees the same performance of both networks for various network architectures.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The terminology used herein is for the purpose of describing particular embodiments of the invention only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

It will be understood that those skilled in the art, both now and in the future, may make various improvements and enhancements which fall within the scope of the claims which follow.

What is claimed is:

1. A computer-implemented method comprising:
accessing neural network (NN) components of a pre-trained analog-signal-based NN;
processing the NN components to generate scaled NN components; and
generating, based at least in part on one or more of the scaled NN components, temporal-coding-based NN components of a temporal-coding-based NN, wherein the temporal-coding-based NN components are dependent on the one or more of the scaled NN components.

2. The computer-implemented method of claim 1, wherein the NN components of the pre-trained analog-signal-based NN comprise layers, weights, and activations.

3. The computer-implemented method of claim 2, wherein processing the NN components comprises:
scaling one or more of the weights to generate scaled weights.

4. The computer-implemented method of claim 3, wherein:
the temporal-coding-based NN comprises a spike-signal-based NN (SSB-NN);
the temporal-coding-based NN components comprise SSB-NN components; and
the SSB-NN components comprise SSB-NN parameters of the SSB-NN.

5. The computer-implemented method of claim 4, wherein the SSB-NN parameters of the SSB-NN are determined based at least in part on the scaled weights.

6. The computer-implemented method of claim 4, wherein the SSB-NN components comprise time intervals for each layer of the SSB-NN.

7. The computer-implemented method of claim 6, wherein processing the NN components further comprises computing a maximum activation output value of each of the layers; and
wherein the time intervals for each layer of the SSB-NN are generated based at least in part on the maximum activation output of the respective layer of the SSB-NN.

8. The computer-implemented method of claim 7, wherein the SSB-NN comprises a single-spike NN.

9. A computer system comprising a processor system electronically coupled to a memory, wherein the processor system is operable to perform processor system operations comprising:
accessing neural network (NN) components of a pre-trained analog-signal-based NN;
processing the NN components to generate scaled NN components; and
generating, based at least in part on one or more of the scaled NN components, temporal-coding-based NN components of a temporal-coding-based NN, wherein the temporal-coding-based NN components are dependent on the one or more of the scaled NN components.

10. The computer system of claim 9, wherein the NN components of the pre-trained analog-signal-based NN comprise layers, weights, and activations.

11. The computer system of claim 10, wherein processing the NN components comprises:
scaling one or more of the weights to generate scaled weights.

12. The computer system of claim 11, wherein:
the temporal-coding-based NN comprises a spike-signal-based NN (SSB-NN);
the temporal-coding-based NN components comprise SSB-NN components; and
the SSB-NN components comprise SSB-NN parameters of the SSB-NN.

13. The computer system of claim 12, wherein the SSB-NN components further comprise time intervals for each layer of the SSB-NN.

14. The computer system of claim 13, wherein the SSB-NN parameters of the SSB-NN are determined based at least in part on the scaled weights.

15. The computer system of claim 13, wherein processing the NN components further comprises computing a maximum activation output of each of the layers;
wherein the time intervals for each layer of the SSB-NN are generated based at least in part on the maximum activation output of the respective layer of the SSB-NN.

16. The computer system of claim 15, wherein the SSB-NN comprises a single-spike NN.

17. A computer program product comprising a computer readable program stored on a computer readable storage medium, wherein the computer readable program, when executed on a processor system, causes the processor system to perform processor system operations comprising:
accessing neural network (NN) components of a pre-trained analog-signal-based NN;
processing the NN components to generate scaled NN components; and
generating, based at least in part on one or more of the scaled NN components, temporal-coding-based NN components of a temporal-coding-based NN, wherein the temporal-coding-based NN components are dependent on the one or more of the scaled NN components.

18. The computer program product of claim 17, wherein the NN components of the pre-trained analog-signal-based NN comprise layers, weights, and activations.

19. The computer program product of claim 18, wherein:
processing the NN components comprises:
scaling one or more of the weights to generate scaled weights; and
computing a maximum activation output of each of the layers;
the temporal-coding-based NN comprises a spike-signal-based NN (SSB-NN);
the temporal-coding-based NN components comprise SSB-NN components;
the SSB-NN components comprise:
SSB-NN parameters of the SSB=NN; and
time intervals for each layer of the SSB-NN; and
the SSB-NN parameters of the SSB-NN are determined based at least in part on the scaled weights; and the time intervals for each layer of the SSB-NN are generated based at least in part on the maximum activation output of the respective layer of the SSB-NN.

20. The computer program product of claim 19, wherein the SSB-NN comprises a single-spike NN.
